(19) United States
(12) Patent Application Publication
(10) Pub. No.: US 2006/0220947 A1
(43) Pub. Date: Oct. 5, 2006

(54) Compact low power consumption microwave distance sensor obtained by power measurement on a stimulated receiving oscillator

(76) Inventors: Andreas Kornbichler, Dietramszell (DE); Martin Nalezinski, Munich (DE); Martin Vossiek, Hildesheim (DE)

Correspondence Address: LERNER GREENBERG STEMER LLP, P O BOX 2480, HOLLYWOOD, FL, 33022-2480, US

(21) Appl. No.: 10/550,974

(22) PCT Filed: Feb. 16, 2004
(86) PCT No.: PCT/EP04/01441

§ 371 Date: Sep. 26, 2005

(30) Foreign Application Priority Data
Mar. 31, 2003 (DE) 103 14 557.5

(51) Int. Cl. G01S 13/08

(52) U.S. Cl. 342/118; 342/175

(57) ABSTRACT

The invention relates to a pulse radar that comprises a receiving oscillator whose transient response is influenced by a received return.

Pulsed radar sensors are often used to measure distances with the aid of microwaves. The methods and arrangements for constructing and operating pulsed radar sensors exist in a plurality of forms and have long been known, for example from documents U.S. Pat. No. 3,117,317, U.S. Pat. No. 4,132,991 and U.S. Pat. No. 4,521,778. Pulsed radar sensors are used in industrial measurement technology as height of fill sensors, in motor vehicles as parking aids or proximity sensors for collision avoidance, and in autonomous vehicles and transport systems, involving for instance conveyor mechanisms and automatic plants, for mapping surroundings and for navigation.

In the applications listed above, pulsed radar sensors usually operate at center frequencies of approx. 1 GHz to 100 GHz with typical pulse lengths of 100 ps to 20 ns. Due to the size of the bandwidth, such sensors have for some time been designated ultrawideband (UWB) radar. Common to almost all pulsed radar sensors is the fact that the pulsed signals have so large a bandwidth that they cannot be directly recorded and processed by the customary signal acquisition methods, and first have to be converted to a lower frequency. For this purpose almost all known pulsed systems use a method known as sequential sampling. According to this principle, already known from early digital sampling oscilloscopes, the measurement signal is sampled over a plurality of measurement cycles, the sampling instants being shifted sequentially from one cycle to the next.

According to documents U.S. Pat. No. 3,117,317, U.S. Pat. No. 4,132,991 and U.S. Pat. No. 4,521,778 the switching technology for implementing the sequential sampling involves sending a transmit pulse at a particular repetition rate CLK-Tx (clock transmission), its return being sampled with the aid of a scanning gate at a repetition rate CLK-Rx (clock reception). If the frequencies of the transmit sequence and the sampling sequence differ very slightly, the two sequences gradually shift their phase relative to one another. This gradual shift in the sampling point relative to the transmit moment produces a sequential sampling process.

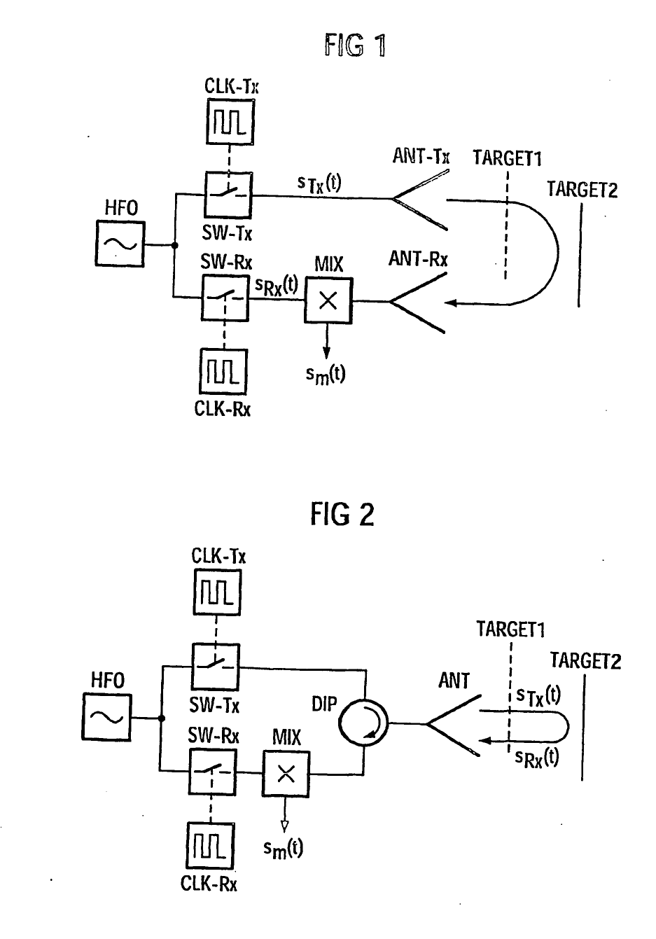

FIG. 1 shows a known embodiment of a pulsed radar having sequential sampling and operating according to the prior art. The output signal of a continuously operating oscillator is split into a transmission path and a reception path. Both these signals are briefly gated via the switches SW-Tx/SW-Rx having the clock CLK-Tx/CLK-Rx, generating two cyclical pulse sequences _{STX}(t) and _{STX}(t) having slightly different clock rates. The pulse sequence _{STX}(t) is transmitted via the antenna ANT-Tx. The pulse sequence _{sRX}(t) is fed to the first gate of the mixer MIX, which acts as a scanning gate. The second gate of the mixer is fed with the receive signal reflected from the objects TARGET1 and TARGET2. The received pulse sequence is mixed into the low-frequency baseband in the mixer MIX. The resulting sample pulse sequence is smoothed by a band-pass filter, producing the low-frequency measurement signal sₘ(t).

As FIG. 2 shows, an embodiment is also known in which a common antenna is used for transmitting and receiving, rather than separate antennas as in FIG. 1, the transmit and receive signals being mutually separated by for example a circulator or directional couplers.

When taking measurements using sequential sampling and the conventional radar topology shown in FIGS. 1 and 2, the following disadvantages arise:

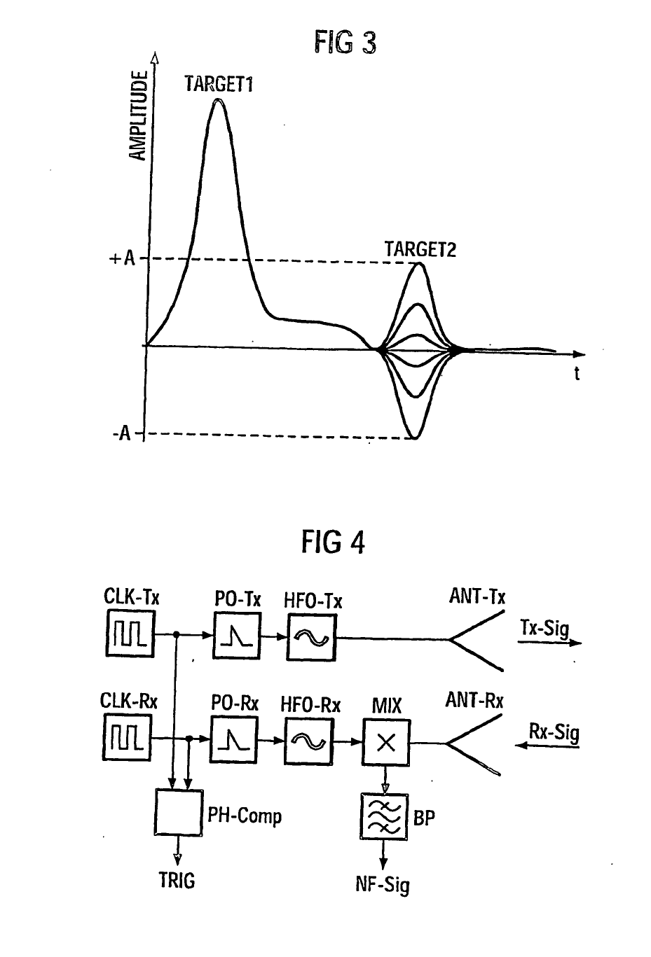

If the measurement signal sₘ(t) is acquired as a real number, the amplitude of the return pulse changes as a function of the specific phase between the transmit signal and the receive signal. If the object TARGET2 moves, the pulse envelope belonging to said object “wafts” back and forth, as shown in FIG. 3 (labeled TARGET2), as a function of the momentary reflection phase between the values +A and −A, determined by the respective distance of the moving object TARGET2, and the position of the pulse envelope moves simultaneously with the changing position of the object. Between these extremes the envelope sometimes disappears completely. If the object to be measured reflects with precisely a phase at which the pulse envelope disappears, the object is not detected.

By acquiring the measurement signal sₘ(t) as a complex value, a pulse envelope that does not “waft”, as shown in FIG. 6, can be formed by computing a value from the real part and the imaginary part of the measurement signal. However, this requires complex measured values to be acquired, which means using two mixers, and two signals Re{sₘ(t)} and Im{sₘ(t)} have to be analyzed.

The switches SW-Tx/SW-Rx enable only a limited amount of switch contrast. This means that a signal is always transmitted and a Doppler signal can be seen between the pulse envelopes. Moreover the transmitted continuous-wave signal can present a problem with regard to the spurious emissions permitted by the authorities.

The oscillator HFO is always on and consuming current. In battery-operated applications this reduces the battery life.

In the case of RF, an oscillator and two switches which are costly to design are needed to generate the pulses.

An arrangement according to FIG. 4 solves some of the problems mentioned. The function corresponds in the main to the arrangement shown in FIG. 1, the pulse sequences in this case being produced by briefly switching on the signal sources HFO-Tx/HFO-Rx by means of a short voltage pulse from PO-Tx/PO-Rx. Here too the resulting pulse sequences have slightly different clock rates CLK-Tx/CLK-Rx.

In order to obtain a good signal-to-noise ratio (SNR) for the measurement signal, it is essential that the oscillators PO-Tx/PO-Rx are in a deterministic, not stochastic phase relation to one another for all the pulses in a sequence. A deterministic relationship is obtained when the pulse signals which switch on the pulsed oscillators HFO-Tx/HFO-Rx are very rich in harmonic components in the frequency band of the radio-frequency oscillators. The harmonics ensure that the oscillators do not build up their oscillations stochastically, but instead have a locked, characteristic start phase relative to the voltage pulses PO-Tx/PO-Rx. Thus the output signals of both oscillators are also in a deterministic phase relation and time relation to one another, determined by the transmit signal sequence and the sampling signal sequence.

The advantages of the arrangement shown in FIG. 4 are:

The system has a significantly lower current drain than that shown in FIG. 1, since the radio-frequency oscillators are switched off for most of the time during a measurement cycle.

The system has no costly radio-frequency switches.

However there are some disadvantages:

A high cost is involved in the generation of sufficiently strong, short voltage pulses that are rich in harmonics.

If the harmonics are very weak, the build up phase is also affected by other intrusive signals and the measurement signal amplitude roars and jitters.

To determine the distance based on the measurement signal it is usually necessary to determine the signal envelope. As a rule this requires the low-frequency measurement signal to undergo very high amplification, which is likewise costly to provide.

In another area of technology, namely that of transponders, it is known from document U.S. Pat. No. 5,630,216 that both the phase and the speed at which an oscillator builds up its oscillations are affected by an induced signal of a similar frequency. This effect is used for the very low-power demodulation of an incoming AM code signal. However, this amplification effect is not suitable for a single-frequency measurement method such as that previously described.

The object of the present invention is to demonstrate systems which fulfill the object of the described radar arrangements in another, improved form.

This object is achieved by means of the inventions specified in the independent claims. Advantageous embodiments will emerge from the dependent claims.

In accordance with this solution, an arrangement or device has transmission means for generating and sending an electromagnetic signal, and also has reception means for receiving a return from the transmitted electromagnetic signal. The reception means has a receiving oscillator whose transient response, in particular the build-up time including the average delivered power, can be influenced by the strength, and particularly the amplitude, of the received reflection of the transmitted electromagnetic signal. The receiving oscillator is therefore wired so that it can be excited and/or stimulated by a reflection of the transmitted electromagnetic signal, and because of this a measurement signal can be generated as a function of the strength, and in particular the amplitude, of the reflection of the transmitted electromagnetic signal.

For this purpose the arrangement preferably has a detector by which the average power of the receiving oscillator can be measured.

It is further advantageous if the arrangement is designed for pulse mode in the transmit and/or receive paths, by fitting the transmission means and/or the reception means with a means for switching on and off periodically. In particular the arrangement can have a means for switching the receiving oscillator on and off periodically using a clock rate.

In a particularly cost-effective and space-saving manner, the receiving oscillator can be wired in such a way that it also acts as the transmitting oscillator for generating the electromagnetic signal for transmission.

Alternatively the arrangement can have a second oscillator acting as the transmitting oscillator for generating the electromagnetic signal for transmission.

In particular the arrangement is an arrangement for measuring distance, a radar, preferably a pulsed radar.

For detecting a measurement signal, said arrangement can have a mixer in which a first measurement sub-signal and a second measurement sub-signal are added together, in particular a mixer with two diodes, such that the said diodes are used with the same polarity, that is to say parallel, the measurement signal being formed by the sum of two measurement sub-signals, or such that the said diodes are used with opposite polarity, that is to say antiparallel, the measurement signal being formed by the difference between the two sub-signals. The advantage in using such a symmetrical mixer consists in the doubling of the measurement signal amplitude and in the particularly good transmission characteristics, which are especially desirable for sending the transmission signal with low attenuation as well as for stimulating the receiving oscillator by means of a receive signal.

In the case of a measurement method, in particular a method for measuring distance:

a means of transmission is used to generate and send an electromagnetic signal,

a means of reception having a receiving oscillator is used to receive a return, that is a reflection, of the transmitted electromagnetic signal,

the transient response of the receiving oscillator, in particular its build-up time including the average delivered power, is influenced by the strength and particularly the amplitude of the reflection of the transmitted electromagnetic signal.

Advantageous embodiments of the method are produced in similar ways to the advantageous embodiments of the arrangement.

Further advantages and features of the invention will emerge from the description of exemplary embodiments, in which;

FIG. 1 shows a pulsed radar according to the prior art;

FIG. 2 shows a second pulsed radar according to the prior art;

FIG. 3 shows a measurement carried out using the pulsed radar according to FIG. 1 or the pulsed radar according to FIG. 2;

FIG. 4 shows a third pulsed radar according to the prior art;

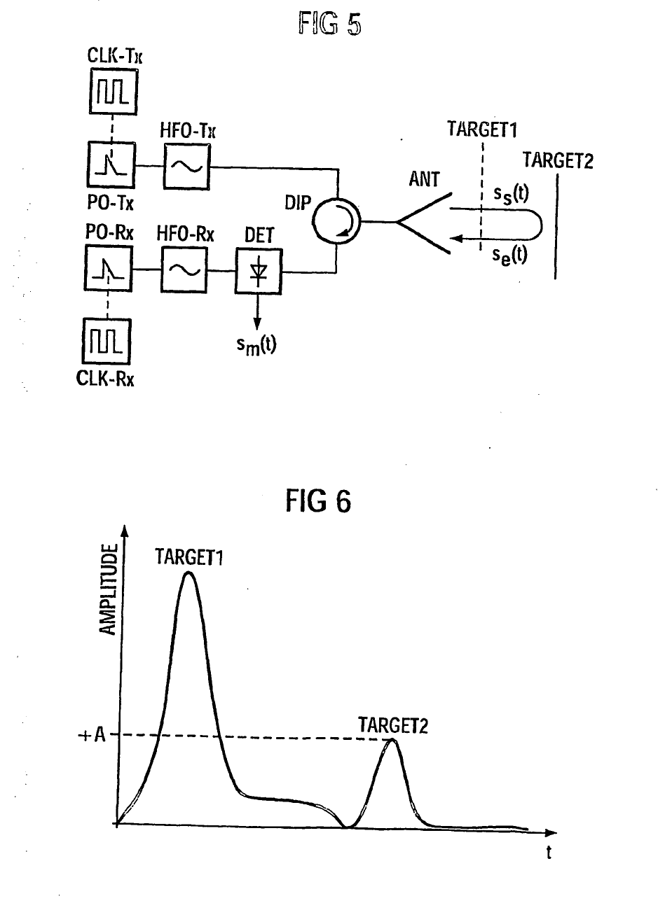

FIG. 5 shows an arrangement with means of transmission and reception;

FIG. 6 shows a measurement carried out using the arrangement according to FIG. 5;

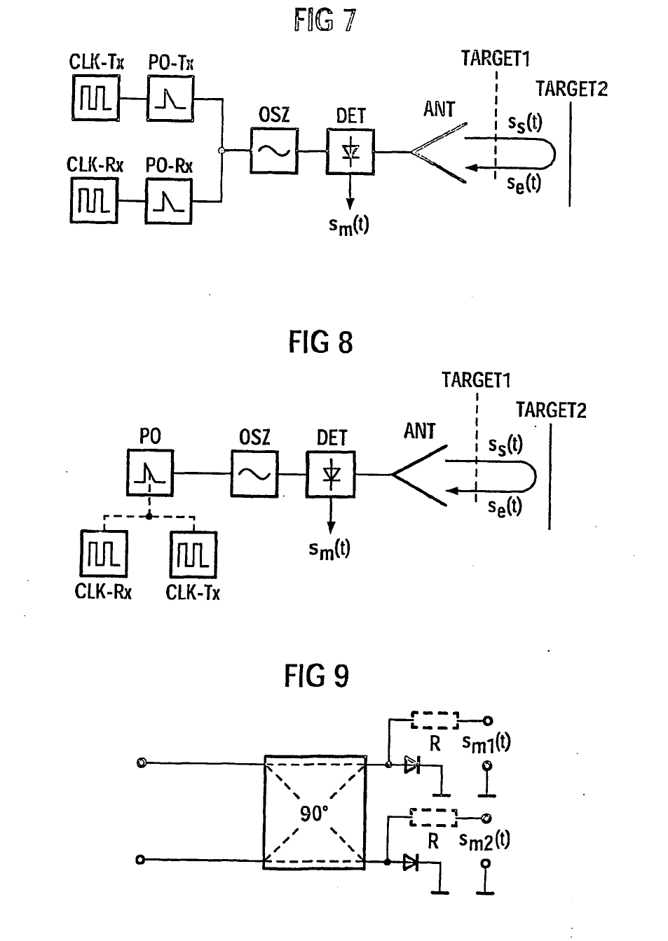

FIG. 7 shows an alternative arrangement with means of transmission and reception;

FIG. 8 shows another alternative arrangement with means of transmission and reception;

FIG. 9 shows a mixer that can be used in the said arrangements.

Arrangements are described below which avoid the disadvantages of the systems in FIGS. 1, 2 and 4.

As already mentioned, both the phase and the speed at which an oscillator builds up its oscillations are affected by an induced signal of a similar frequency. When influenced by a received signal of a similar frequency, an oscillator which is periodically switched on and off builds up its oscillations more quickly than would be the case without such a signal. The greater the amplitude of the incoming signal at the switched oscillator, the shorter the settling time of the oscillator and the longer it oscillates during a given operating time.

If the output signal from a switched oscillator which has been stimulated by a receive signal is fed through a low pass filter to a detector DET, the function of said detector in this arrangement is that of a power meter which measures the average power output of the stimulated oscillator. If the oscillator is stimulated by an AM receive signal, the average output power of the oscillator fluctuates as a function of the signal amplitude of the stimulating signal being received by the oscillator at any given moment. The measurement signal sₘ(t) is thus a highly amplified representation of the AM receive signal.

In the present case, the switched-oscillator amplification effect is used to produce a very simple proximity radar with extremely low power consumption according to the sequential sampling method. Such a radar system is shown in FIG. 5.

This radar system has a transmitting oscillator HFO-Tx which is periodically switched on briefly by means of a fast-acting switch PO-Tx with a clock rate CLK-Tx. Typical on periods are 100 ps-20 ns and typical clock rates are 0.1-10 MHz. The signal is transmitted via a diplexer DIP, which in the case shown takes the form of a circulator. After being reflected from an object, said signal is received back via the diplexer DIP and passes through a detector DET to a receiving oscillator HFO-Rx. Said receiving oscillator HFO-Rx is in the form of a local oscillator and is switched on and off by a switch PO-Rx with a clock rate CLK-Rx. If components of the reflected receive signal are present on the local oscillator HFO-Rx at the moment it is switched on, due for example to the practically unavoidable coupling of the receiving antenna via the detector DET to the local oscillator HFO-Rx, then as described above, these signals cause the oscillator to start up more quickly in comparison with the case when the oscillator starts up due to noise. During distance measurement, the incoming returns are distributed over time and vary in strength according to the reflector scenario. Thus receive signals of varying strength travel via the antenna ANT, diplexer DIP and detector DET to the local oscillator HFO-Rx. The strength of the reflection at the moment of switching on is represented as the average on period of the oscillator, that is to say, the average oscillator power. The detector DET uses this average oscillator power to form the pulse envelope shown in FIG. 6.

The advantages of this system topology and measurement method are shown in the following points:

Since the measurement signal sₘ(t) is generated by power detection rather than by a coherent mixing method, there is no “wafting” of the signal amplitude relative to the phase of the reflection, even for a moving reflector TARGET2. The measurement signal therefore does not need to be generated as a complex value.

Typical reflections give rise to a range of measurement signal amplitudes amounting to some hundreds of millivolts, in contrast to mixed signals which, in a coherent system, typically amount to a few tens of millivolts. It is thus possible to make savings on amplifier stages of 20-30 dB in the LF range without additional expenditure on switching technology in the RF range.

The radar system then requires extremely low power consumption in order to work.

At RF frequencies, only two oscillators are needed to generate the pulses. Obtaining the harmonics content in the voltage pulses generated by the switches does not involve the demanding requirements found in the case of the voltage pulses from the switches SW-Rx or SW-Tx for the arrangement seen in FIG. 4.

FIG. 7 shows a particularly simple embodiment of the radar system. The oscillator HFO acts both as a transmitting oscillator and as a stimulated receiving oscillator which is switched on not only by the switch PO-Tx with the clock rate CLK-Tx, but also by the switch PO-Rx with the clock rate CLK-Rx. Alternatively switching on can also be handled by an arrangement such as that shown in FIG. 8. A precondition for this however is a switch that can produce extremely fast pulse repetition rates.

It is advantageous but not imperative if the detector DET in the system shown in FIG. 7 and FIG. 8 takes the form of a symmetrical mixer based on a 90° hybrid (for an example see A. Maas: “The RF and Microwave Circuit Design Cookbook”, Artech House 1998, pp. 107-109), as shown in FIG. 9 with a distinguishing feature. The said distinguishing feature consists in the fact that both diodes, as in the case of a frequency doubler, are used with the same polarity, that is to say parallel, the measurement signal being formed however by the sum of two measurement sub-signals sₘ₁(t) and sₘ₂(t), or the said diodes are used with opposite polarity, that is to say antiparallel, the measurement signal being formed by the difference between the two sub-signals. By this means the amplitude of the measurement signal is doubled in comparison with an arrangement using only one diode or picking up only one of the sub-signals sₘ₁(t) or sₘ₂(t). The advantage in using a symmetrical mixer according to FIG. 9 consists further in its particularly good transmission characteristics, which are especially desirable for stimulating the oscillator by means of a receive signal.

Unlike the mixer shown here, in a conventional mixer the measurement signal is formed by either using the two diodes in antiparallel mode and adding the sub-signals together or using the diodes in parallel and subtracting the two sub-signals. In contrast to a conventional mixer, the diodes in the mixer introduced here are not adjusted to give low reflection, but are deliberately intended to be highly resistive and thus reflective (typically 100Ω-100 kΩ in a 50-Ω system). If necessary a series resistor R can be wired in series with the diodes in order to obtain the highly resistive characteristic.

Besides the advantages already mentioned for the system shown in FIG. 5, it is also true to say that this system is very simple. Only one RF oscillator is needed for generating the pulses.

### Embodiments

Using the radar sensor described, all the other methods commonly used in pulsed radar systems for measuring distance can also be used in place of the sequential sampling method. A radar system can then be made sensitive to only one given proximity range by making the two clock rates CLK-Tx and CLK-Rx identical but offset relative to each other by one time period corresponding to the signal propagation time between the sensor and the proximity range being monitored. In this operating mode the system could be used as an excellent and very cost-effective limit switch (for instance in industrial measurement technology for height of fill to prevent overflow or under-filling) or as a type of radar barrier (for example to count and/or detect persons and vehicles, or to detect objects on flow lines).

Similarly [neither] the clocks CLK-Tx and CLK-Rx nor the offset of the clocks relative to one another need be regular in order to produce a complete distance profile, but it is also possible to create a series of sampled values according to any scheme (e.g. stochastic or coded) via the object scene and then assign and allocate the distance measurement points correctly in relation to one another in an analytical unit. Further methods for operating the radar are imaginable.

In place of the circulator seen in FIG. 5, the separation between transmission and reception can also be achieved with the aid of a directional coupler, or may be dispensed with entirely. In the latter case the antenna can be connected via a single spur line. However, significantly worse distance measurement performance is to be expected in this instance, since direct crosstalk from the transmission path to the reception path, or reflected signals on the spur line, have the same effect as a very close reflector.

As is usual with pulsed radar systems, the unambiguous range of the radar is defined by the pulse repetition rate. Reflected pulses which arrive at the radar sensor only after the next outgoing pulse has been transmitted are interpreted as very close reflectors. Since the average received energy defines the S/N ratio, it is desirable to choose a high pulse repetition rate and thus inevitably the narrowest possible unambiguous range.

The order of magnitude of the on period of CLK-Tx and CLK-Rx must be within the range Q oscillation cycles of the oscillators HFO-Tx/HFO-Rx, where Q represents the weighted quality of the resonator in the oscillator. Otherwise the oscillator cannot completely build up to its maximum amplitude during the settling time. In this respect the resonator should have as low a quality as possible.

Unlike many pulsed radar sensors (such as that in FIG. 4) it is not necessary for the starting pulse to build up particularly steeply and generate harmonics in the radio frequency range.

Because of their particularly simple and cost-effective structure, the radar arrangements are ideally suited for all cost-sensitive applications. Those which should be singled out for mention are proximity sensors around motor vehicles (parking aids, blind-spots, airbags, pre-crash detection, automatic navigation and sensors in general for autonomous vehicles), proximity sensors inside motor vehicles (seat occupancy monitoring, intrusion alarms, crush protection systems for windows and sliding roofs), the entire range of industrial distance sensors and the range of sensors for household use (monitoring of windows, doors, rooms and boundaries).

1-12. (canceled)

13. A transceiver assembly, comprising:
a transmitter for sending a transmission signal;
a receiver for receiving a reflection signal formed by a reflection of the transmission signal, said receiver having a receiving oscillator with a transient response influenced by the reflection signal.

14. The assembly according to claim 13, wherein at least one of a build-up time and an average delivered power of said receiving oscillator is influenced by the reflection signal.

15. The assembly according to claim 13, wherein a power of said receiving oscillator can be measured.

16. The assembly according to claim 13, which further comprises means for switching said receiving oscillator on and off.

17. The assembly according to claim 16, wherein said means is configured to switch said receiving oscillator periodically following a clock rate.

18. The assembly according to claim 13, wherein said receiving oscillator is also a transmitting oscillator for generating the transmission signal.

19. The assembly according to claim 13, which further comprises a transmitting oscillator for generating the transmission signal.

20. The assembly according to claim 13, which further comprises a mixer configured to add together a first measurement sub-signal and a second measurement sub-signal.

21. The assembly according to claim 13, which further comprises a mixer with two diodes connected with a same polarity, and wherein a measurement signal is formed by a sum of two measurement sub-signals.

22. The assembly according to claim 13, which further comprises a mixer with two diodes connected with opposite polarity, and wherein a measurement signal is formed by a difference between two measurement sub-signals.

23. A distance-measurement assembly, comprising:
a transmitter for sending a transmission signal towards a target;
a receiver for receiving a reflection signal formed by a reflection of the transmission signal at the target, said receiver having a receiving oscillator with a transient response influenced by the reflection signal.

24. The assembly according to claim 23, wherein said transmitter is a radar transmitter.

25. The assembly according to claim 23, wherein said transmitter is a pulsed radar transmitter.

26. The assembly according to claim 23, which further comprises a mixer configured to add together a first measurement sub-signal and a second measurement sub-signal.

27. The assembly according to claim 23, which further comprises a mixer with two diodes connected with a same polarity, and wherein a measurement signal is formed by a sum of two measurement sub-signals.

28. The assembly according to claim 23, which further comprises a mixer with two diodes connected with opposite polarity, and wherein a measurement signal is formed by a difference between two measurement sub-signals.

29. In combination with a motor vehicle, the assembly according to claim 23.

30. In combination with a building, the assembly according to claim 13.

31. In combination with an industrial plant, the assembly according to claim 13.

32. A measurement method, which comprises:
generating and transmitting a transmission signal with a transmitter;
receiving a reflection of the transmitted signal with a receiver having a receiving oscillator; and
influencing a transient response of the receiving oscillator with the reflection of the transmitted signal.

33. The measurement method according to claim 32, which comprises measuring a distance to a target.
